(19) United States
(12) Patent Application Publication
(10) Pub. No.: US 2023/0021643 A1
(43) Pub. Date: Jan. 26, 2023

(54) METHOD FOR PROVIDING A THREE-DIMENSIONAL MAP IN A MOTOR VEHICLE

(71) Applicant: AUDI AG, Ingolstadt (DE)

(72) Inventors: Rebekka NEUMANN, Gaimersheim-Lippertshofen (DE); Timo WARNTJES, Garching (DE); Ronny HEINZELMANN, Ingolstadt (DE); Christina SCHMID, Berching (DE); Carlo VOIGT, Gaimersheim (DE)

(73) Assignee: AUDI AG, Ingolstadt (DE)

(21) Appl. No.: 17/783,887

(22) PCT Filed: Nov. 20, 2020
(86) PCT No.: PCT/EP2020/082882

§ 371 Date: Jun. 9, 2022

(30) Foreign Application Priority Data
Dec. 10, 2019 (DE) 10 2019 133 613.9

(51) Int. Cl. G01C 21/36; B60W 50/14

(52) U.S. Cl. CPC G01C 21/3638; B60W 50/14; G01C 21/3647; B60W 2050/146

(57) ABSTRACT

A motor vehicle has at least one driver assistance system and a navigation system that generates a three-dimensional map and a route-related navigation representation when route guidance is activated by the navigation system. When the at least one driver assistance system is activated, sensor data describing the surroundings of the motor vehicle are acquired by at least one sensor unit of the motor vehicle according to a data acquisition rule of the driver assistance system. The acquired sensor data is evaluated to generate at least one driver assistance related additional information representation. The map with the route-related navigation representation and the driver assistance related additional information representation are output by a display device in the motor vehicle.

### CROSS REFERENCE TO RELATED APPLICATIONS

This application is a U.S. national stage of International Application No. PCT/EP2020/082882, filed on Nov. 20, 2020. The International Application claims the priority benefit of German Application No. 10 2019 133 613.9 filed on Dec. 10, 2019. Both the International Application and the German Application are incorporated by reference herein in their entirety.

### BACKGROUND

Described below are a method for providing a three-dimensional map in a motor vehicle and a motor vehicle which is designed to carry out such a method.

A motor vehicle presently in general has a display device, which is arranged, for example, in the region of a center console of the motor vehicle and/or in the region of a dashboard of the motor vehicle. This display device is designed to display a map of the surroundings of the motor vehicle in case of an activated navigation system of the motor vehicle. Route-related navigation representations are typically shown in this map, for example, a route representation in the form of a colored highlighted line and/or a navigation notice representation, for example, a turnoff arrow.

DE 10 2007 014 674 A1 discloses a navigation device which extracts an item of visual information of an object on a road by an imaging processor, displays it located in a map depiction, and emphasizes if a position of the object on the road corresponds to a guide point, for example, an intersection. For this purpose, the items of visual information of the object on the road are extracted and analyzed from an image acquired using an acquisition device.

DE 10 2012 216 144 A1 discloses a method for the contact-analogous display of a navigation notice for a driving maneuver of a vehicle, for example, a lane change. In this case, navigation notices are shown on a display of a head-up display, which indicate, for example, a change of the vehicle from a current lane to another lane with the aid of corresponding suggestion signs, such as arrows arranged adjacent to one another. A visualization of a route guidance is thus described by a navigation system of the vehicle.

DE 10 2008 045 994 A1 discloses a method for displaying items of information in a vehicle. A geographic map is displayed in this case on a display surface, within which a symbol for the vehicle is displayed. The position of the symbol of the vehicle changes in relation to the geographic map as a function of the geographic position of the vehicle. Moreover, additional items of information can be displayed for the road map, for example, a traffic sign, wherein these additional items of information are stored in a memory of the motor vehicle.

### SUMMARY

Described below is a method by which an intuitive acquisition of items of information relevant for a driving behavior of the motor vehicle is enabled in the motor vehicle.

The method is based on the finding that it is often advantageous for an intuitive acquisition of a user of the motor vehicle of items of information relevant for a driving behavior of the motor vehicle if an extensive map is provided in the motor vehicle. When selecting contents for this extensive map, it is to be taken into consideration that presently not only a navigation system is often activated in a motor vehicle, but rather also at least one driver assistance system. A driver assistance system is understood as a vehicle function which is designed to at least semi-autonomously control a drive, a steering system, a brake, a signaling unit, and/or a warning unit of the motor vehicle. In contrast, the navigation system of the motor vehicle is designed to determine a route guidance of the motor vehicle from a current position to a predetermined target position and, for example, to display a route-related navigation representation to the user of the motor vehicle in a map displayed in the motor vehicle. In general, only the items of information of the navigation system, that is to say the route-related navigation representation and possibly further navigation notice representations, are displayed on a display device of a motor vehicle in case of a map displayed there. However, it is often advantageous for the intuitive acquisition of the items of information relevant for the driving behavior of the motor vehicle if the user, in addition to the route-related navigation representation, is additionally displayed items of information relating to his surroundings in the map, which are provided by the currently activated driver assistance system. A map which is particularly advantageous for the user, for example, for a driver and/or a front passenger, and which is displayed in the motor vehicle, thus represents a combination of a typical navigation map and items of information from driver assistance systems and can be referred to, for example, as an integrated driving display. The items of information from various driver assistance systems are ultimately integrated in map material already known from the navigation system.

The method for providing a three-dimensional map in a motor vehicle is based on the motor vehicle having a navigation system and at least one driver assistance system. According to the method, the display and provision of a three-dimensional map, that is to say three-dimensional map material, is always provided for this purpose in that therefore both a road representation and also, for example, a representation of buildings and other surroundings elements, for example, a traffic signal system, takes place three-dimensionally.

The method begins with a three-dimensional map generated by the navigation system of the motor vehicle. The generated map displays the surroundings of the motor vehicle in a three-dimensional representation. Map data typically stored in a navigation system can be used for this purpose, which are evaluated to form the three-dimensional map.

Next, a route-related navigation representation is generated in the generated map by evaluating navigation system data of the navigation system, if a route guidance by the navigation system is activated. For example, if the user of the vehicle has indicated that he wishes a route guidance from a current position and/or from an already departed starting position to a predetermined target position, a route for the motor vehicle is determined with the aid of the navigation system. The route guidance by the navigation system is therefore activated. As the route-related navigation representation, it is thereupon formed in the generated map, which represents, for example, the road on which the motor vehicle is currently driving, as the route representation. For this purpose, for example, a planar vehicle guidance region, for example, in the form of a vehicle guidance carpet, is displayed in the three-dimensional map which indicates in which direction the motor vehicle is to move to drive along the determined route to the target position. If the active route guidance by the navigation system is provided this is thus indicated in the navigation map and therefore also in the three-dimensional map of the integrated vehicle display generated here. Additionally or alternatively to the representation of the active route guidance, a position of the motor vehicle itself and a maneuvering notice for the motor vehicle, for example an arrow, can be shown in the three-dimensional map. Furthermore, a distance to a location of a next driving maneuver and/or a small-scale representation of the next driving maneuver can be continuously displayed, for example, with the aid of one or more arrows.

It is moreover provided according to the method that it is checked whether the at least one driver assistance system of the motor vehicle is activated. If the at least one driver assistance system is activated, predetermined sensor data describing the surroundings of the motor vehicle are acquired by at least one sensor unit of the motor vehicle. This sensor data acquisition takes place according to a data acquisition rule of the at least one activated driver assistance system. If the activated driver assistance system is, for example, a lane keeping assistant, according to the data acquisition rule of the lane keeping assistant, lane markings in the surroundings of the motor vehicle are acquired by the sensor unit. A front camera, at least one side camera, and/or a rear camera of the motor vehicle, that is to say a camera system of the motor vehicle, for example, are suitable as the sensor unit for this purpose. The data acquisition rule additionally includes, for example, an evaluation rule, which is based on image processing methods and according to which in the sensor data describing the surroundings of the motor vehicle, an object relevant for the driver assistance system that is activated can be recognized and evaluated. In the case of the activated lane keeping assistant, for example, the camera data of the front camera as a sensor unit of the motor vehicle are evaluated in such a way that a relative arrangement of lane markings, for example, a roadway edge marking and/or a central strip marking, can be determined in relation to one another and in relation to the motor vehicle. By evaluating the acquired sensor data, at least one driver assistance system-related additional information representation of the generated map is then generated. In this example, the driver assistance system-related additional information representation is, for example, a highlighted representation of the central strip marking and the roadway edge marking of the road on which the motor vehicle is currently driving. With the aid of the highlighted representation, which is implemented, for example, by a predetermined coloration of the roadway markings, a type of warning takes place, that is to say the user is made aware that in consideration of precisely these highlighted lane markings, the currently active driver assistance system activates, for example, a steering system of the motor vehicle. A corresponding evaluation algorithm is stored for this purpose in the motor vehicle, which is applied, for example, by an evaluation unit of the sensor unit, a control unit of the motor vehicle, and/or a control unit of the activated driver assistance system to the sensor data. The driver assistance system-related additional information representation is then designed, for example, as a three-dimensional representation recreating the actual roadway marking. If multiple driver assistance systems are activated, for example, multiple driver assistance system-related additional information representations are generated.

Finally, the generated map having the generated route-related navigation representation and the generated at least one driver assistance system-related additional information representation is provided in the motor vehicle by a display device of the motor vehicle. This display device may be arranged in the region of a center console of the motor vehicle and/or in the region of a dashboard of the motor vehicle. The visual map can, in addition to representing a three-dimensional map in general, include further typical components for a map of a navigation system, for example, details on a type of road, items of traffic volume information, items of information on further road and path courses in the surroundings of the motor vehicle, and/or a dynamic adaptation of a position of objects in the three-dimensional map to a driving movement of the motor vehicle. In the event of a position change of the motor vehicle, individual representation objects of the three-dimensional map thus also experience a displacement movement, to represent the motor vehicle movement.

Using the provided three-dimensional map in the motor vehicle, a combination takes place of a classic navigation map and additional items of information from the at least one activated driver assistance system. In this way, a map is provided for the user of the motor vehicle which has numerous items of information currently relevant for him relating to his current driving situation and the auxiliary systems currently activated in the motor vehicle. The three-dimensional map provided here thus enables an intuitive, easy, fast, and comfortable access to a plurality of items of information currently relevant for the driving behavior of the motor vehicle in the motor vehicle, which are provided bundled in the form of the integrated driving display, that is to say in the provided map. In this way, ultimately a particularly extensive map for the motor vehicle is provided in the motor vehicle.

In the embodiments, additional advantages result. In one advantageous embodiment, at least one of the following representations is generated as driver assistance system-related additional information representations: on the one hand, a maneuvering notice can be generated. In this case, this is in particular a directional arrow and/or a driving tube. The maneuvering notice thus indicates, for example, to what extent and how the activated at least one driver assistance system at least semi-autonomously intervenes, for example, in the steering system of the motor vehicle. With the aid of, for example, directional arrows arranged at varying distances from one another, a speed behavior of the motor vehicle and thus an intervention of the activated driver assistance system on the drive or the brake of the motor vehicle can moreover be indicated. In this case, for example, a distance between individual short directional arrows would decrease if the motor vehicle accelerates and the corresponding distance between the individual directional arrows would increase if the motor vehicle is at least semi-autonomously braked. Alternatively or additionally thereto, a degree of a sweep, that is to say a bend of an arrow between an arrow beginning at an arrow tip, and/or a speed of a moving animation of the directional arrow can be changed accordingly.

The driver assistance system-related auxiliary representation may, for example, include a driving tube, which indicates to the user of the motor vehicle that he is driving along the current road remaining on his current roadway due to the currently activated lane keeping assistant. Alternatively or additionally to a representation of a driving tube, arrows can be displayed in the driving direction on the left and/or right of a position of the motor vehicle in the generated map, which indicate that the motor vehicle is kept in the middle on a current lane. In the case of an intervention of the lane keeping assistant on the steering system of the motor vehicle, for example, in a situation in which the motor vehicle threatens to inadvertently leave the current lane, this can be shown with the aid of directional arrows, which point toward the current lane, in the three-dimensional map as a driver assistance system-related additional information representation. The user thus learns quickly and intuitively that currently the lane keeping assistant is activated as an activated driver assistance system and moreover was active in this moment to assist the user of the motor vehicle during the current journey of the motor vehicle.

In particular with the activated maneuvering assistant, lane change assistant, turnoff assistant, evasion assistant, and/or adaptive cruise control, such maneuvering notices of a driver assistance system are helpful for the user for the information representation relating to the respective activated driver assistance system. This is because the user can thus immediately see and comprehend how the activated driver assistance system presently acts on the driving behavior of the motor vehicle.

The driver assistance system-related additional information representation can be, alternatively or additionally to the maneuvering notice, a symbol describing a road situation. Such a symbol is in particular a lane boundary, an infrastructure representation, and/or a traffic sign. An infrastructure representation is understood here, for example, as a representation of a traffic signal and/or an intersection. A traffic sign is displayed, for example, as a road sign, which stands on an edge of the road on which the motor vehicle is presently driving, in the form of a corresponding symbol. In particular with the activated lane keeping assistant, moreover the boundary of the current lane, that is to say a lane marking, is highlighted and represented using a corresponding symbol. The symbol describing a road situation is of interest, for example, with an activated traffic signal information assistant, intersection assistant, a predictive speed limit, and/or an adaptive driving assistant.

Alternatively or additionally thereto, a warning notice can be displayed as a driver assistance system-related information representation. This warning notice is suitable, for example, with an activated congestion pilot, an activated local hazard warning, and/or an emergency braking assistant for displaying the actions currently carried out by the activated driver assistance system. For example, if traffic congestion is acquired and the congestion pilot is activated, a congestion symbol can be displayed as a warning notice in the context of the generated three-dimensional map.

Alternatively or additionally thereto, a motor vehicle representation of another motor vehicle located in front of the motor vehicle and/or laterally to the motor vehicle can be displayed. With an activated congestion pilot, adaptive cruise control, evasion assistant, lane keeping assistant, and/or parking assistant, this can be helpful, for example, to visually highlight other motor vehicles in the surroundings of the motor vehicle, which are relevant for the functionality of the activated driver assistance system. For example, an activated congestion pilot and/or an activated adaptive cruise control will acquire the front vehicle driving in front of the motor vehicle with the aid of the sensor unit and by analyzing the acquired sensor data use it for controlling its driver assistance function since, for example, a current distance to the front vehicle and a speed difference between a speed of the motor vehicle and an acquired speed of the front vehicle is particularly relevant for the function of the respective driver assistance system. The driver assistance system thus uses the front vehicle for its functionality, because of which the corresponding motor vehicle representation of the front vehicle in the provided map represents a representation of an item of driver assistance system-related additional information.

Alternatively or additionally thereto, a notification representation with respect to another motor vehicle approaching the motor vehicle from the rear and/or another motor vehicle driving laterally to the motor vehicle can be displayed as a driver assistance system-related additional information representation. This notification representation can be, for example, a corresponding symbol, an arrow representation, and/or a notification symbol. A behavior of a rear vehicle has influence, for example, on an adaptive driving assistant and/or a parking assistant, because of which items of information relevant for the function of the driver assistance system can also be shown with the aid of the notification representation in the generated three-dimensional map in the form of the driver assistance system-related additional information representation.

The other motor vehicle shown as a motor vehicle representation and/or notification representation can be, for example, a passenger vehicle, a truck, and/or a motorcycle. Alternatively or additionally thereto, a corresponding representation of a bicycle and/or a pedestrian is possible.

Overall, it is shown here that with the aid of the driver assistance system-related additional information representation, a bandwidth of varying and differing items of information, which are provided by the driver assistance system and are ultimately relevant and possibly decisive for the function of the driver assistance system, can be displayed in the three-dimensional map in addition to the navigation representations already provided by the navigation system. These driver assistance system-related additional information representations may be shown for this purpose in the correct position in the map material on which the map is based and adapted to a road geometry. The driver can therefore create an overview upon a rapid glance at the three-dimensional map about which driver assistance systems of the motor vehicle are activated at all and, if they are activated, how they presently act or could act on the motor vehicle if, for example, in the case of a semiautonomous driver assistance system function, a cooperation of the user of the motor vehicle is required to control the motor vehicle according to the specifications of the driver assistance system.

In a further particularly advantageous embodiment, it is provided that if the activated at least one driver assistance system carries out a driver assistance system function in consideration of an object in the surroundings of the motor vehicle described with the aid of the acquired sensor data, an object representation of the object is located in a map. By a predetermined marking, this object representation is highlighted and provided highlighted in the map. This object is, for example, the above-described front vehicle and/or an infrastructure object, for example, a traffic signal, an intersection, or another object describing a road situation. For example, if the sensor unit of the motor vehicle, which in this example is the front camera, acquires the front vehicle of the motor vehicle, this front vehicle is evaluated as the object described by the acquired sensor data, for example, by the adaptive cruise control, in such a way that it maintains a predetermined distance to this object, i.e., the front vehicle. The front vehicle is thereupon specially highlighted in the generated map, for example, in that it is shown as a three-dimensional motor vehicle marked in color. In this way, it is made clear to the user of the motor vehicle that presently a control event of the activated driver assistance system, that is to say the activated adaptive cruise control here, is taking place in consideration of precisely this object in the surroundings of the motor vehicle. As soon as the driver assistance system thus regulates to another motor vehicle in the surroundings of the motor vehicle, precisely this other motor vehicle is shown accurately in position in the map and marked as a regulating event with the aid of the predetermined marking. In the case of an adaptive driver assistant as the activated driver assistance system, it is possible to regulate to traffic signs and/or road events, for example, an intersection and/or a traffic signal. The corresponding representation of the traffic sign and/or the road event as the object can also be provided specially highlighted in the map by the marking. Alternatively or additionally thereto, predetermined representation elements can be provided, which represent a current distance of the motor vehicle to the object.

In this way, for example, it becomes intuitively clear to the user that the driving behavior of the front vehicle, a situation of an intersection, and/or a status of a traffic signal is taken into consideration by the activated driver assistance system and he therefore does not have to worry, for example, about a collision accident relating to the front vehicle or about driving further at a red traffic signal, since the driver assistance system already takes into consideration the driving behavior of the front vehicle or the status of the traffic signal, and controls the motor vehicle according to the items of information obtained here. These additional items of information relevant for the driving behavior of the user are implemented with the aid of the predetermined marking of the object in the map in a manner easily comprehensible for the user.

In an additional embodiment, it is provided that the route-related navigation representation includes a route representation of at least a subsection of a route of the motor vehicle and/or a navigation notice representation. The navigation notice representation is designed in particular as a symbol describing a current or a future road situation. The route-related navigation representation, which is generally shown in the three-dimensional map, can thus represent, for example, a marking of the route from the current position to the predetermined target position, which is located, for example, as a tube and/or line marked by color in the map. Optionally, it is possible not to display the entire route but rather only a current subsection, which can be reasonable, for example, due to a current scale of the map and/or an overall length of the route. The navigation notice representation relating to the current and/or future road situation can be represented, for example, in the form of a traffic sign, a turnoff arrow, driving tube, a directional arrow, and/or another symbol typical for a navigation system. A current and/or future speed limit can be displayed here, for example. The route-related navigation representation is independent in this case from the activated driver assistance system and solely relates to the navigation system data processed by the navigation system and external data, for example describing a current traffic situation, possibly received by the navigation system. These data received from an external unit can be provided, for example, by an external server unit and/or another motor vehicle. It is possible to make use for this purpose of methods and technologies known from typical navigation systems. The three-dimensional map thus contains all elements typical for a map provided by a navigation system, in particular the representation of the route and the navigation notices. The integrated driving display thus solely represents an expansion of the represented contents in comparison to currently existing display contents in a motor vehicle, since typical navigation representations are supplemented by the driver assistance system-related additional information representations. In this way, the additional information gain for the user of the vehicle by the three-dimensional map is particularly clear.

According to an additional embodiment, it is provided that the current navigation notice representation describing the current road situation is positioned in the map at a predetermined navigation notice representation position. If, for example, the navigation notice representation is a traffic sign, which indicates, for example, a current highest speed, it can be provided that a corresponding representation symbol, which represents just this traffic sign, for example, is arranged at a permanently predetermined position on the generated map. This position can be arranged, for example, in an edge region of a display region of the map on the display device. If a current position of the motor vehicle itself is shown in the generated map, the predetermined navigation notice representation position can be arranged laterally to, above, and/or below the corresponding symbol.

The future navigation notice representation describing the future road situation is generated by evaluating the navigation system data. For example, it can be stored in a navigation system of the motor vehicle that at a predefined distance a speed limit on the road changes, which is indicated there by a further traffic sign. However, up to this point the motor vehicle is not yet in a region in which, for example, it can acquire this further traffic sign by a sensor unit. By evaluating the navigation system data, however, it is already known that this future traffic sign is to be expected. A corresponding future navigation notice representation can therefore be generated. The future navigation notice representation is located in the map. The future navigation notice representation is initially located in the map where the actual traffic sign is arranged. The navigation notice representation is thus located, for example, at a specific distance from the current position of the motor vehicle on the three-dimensional map.

Alternatively or additionally thereto, it is provided that the motor vehicle has a traffic sign recognition as a driver assistance system, which is designed to check an output of the navigation system relating to traffic signs by image data of traffic signs in the surroundings of the motor vehicle provided by a camera unit of the motor vehicle. This has the advantage that a display of a traffic sign in the generated map always occurs only when it was previously validated that the display of the traffic sign is correct and currently valid.

During a forward movement of the motor vehicle in the direction of a location at which the future traffic sign is valid, the generated future navigation notice representation is represented traveling in the map to the navigation notice representation position. The motor vehicle thus currently moves, for example, toward the further traffic sign, so that the position of the future navigation notice representation, that is to say the further traffic sign, changes within the generated map as the motor vehicle moves forward in such a way that it ultimately travels into the region in which the current navigation notice representation is displayed. An arrival time of the future traffic sign in the navigation notice representation position may correspond to the time of the beginning of the validity of the future traffic sign as the new current traffic sign. Ultimately, the current navigation notice representation is thus replaced by the future navigation notice representation, wherein this replacement does not take place abruptly but rather with the aid of the described movement of the future traffic sign to the position of the current traffic sign. This travel is carried out in dependence on a forward movement direction and a forward movement speed of the forward movement of the motor vehicle. If the motor vehicle turns off, for example, before reaching the further traffic sign, so that this traffic sign will not unfold any validity for the motor vehicle at all, no travel of the future navigation notice representation to the navigation notice representation position occurs, for example. Instead, for example, a third traffic sign arranged on the road onto which the motor vehicle has turned off can be provided as the new future navigation notice representation, so that now this third traffic sign is moved according to the forward movement of the motor vehicle to the navigation notice representation position. Alternatively or additionally to the described travel of the future navigation notice representation, the future navigation notice representation can initially be shown as transparent, wherein the future navigation notice representation is only no longer shown as transparent when it replaces the navigation notice representation current up to this point as the new current navigation notice representation. In addition to the current traffic sign, for example, future traffic signs are those also shown in the map and travel, for example, along the edge of the road, up to the position of the current traffic sign, that is to say to the navigation notice representation position. The correspondingly shown navigation notice representation is then replaced accordingly, i.e., the current navigation notice representation is replaced by the future navigation notice representation since this is now the current navigation notice representation, whereas the navigation notice representation current up to this point becomes the past and no longer current navigation notice representation, which is now no longer displayed. Similarly to the described traffic sign as the navigation notice representation, in this case this can also be, for example, a symbol describing a road situation, for example, a representation of an intersection, a traffic signal, and/or another road event. Such a symbol can also be arranged, for example, at the navigation notice representation position or can travel thereto.

In this way, it is made possible for the user of the motor vehicle to be informed predictively about future items of information relating to the navigation system or a route. This is because the future navigation notice representation is already displayed before its actual validity in the generated map, so that early and intuitively comprehensible informing of the user of the motor vehicle relating to a future driving condition and/or driving situation is more strongly provided by the approach of the current position of the future navigation notice representation to the predetermined navigation notice representation position. In this way, the generated map is supplemented by further items of information which are practically valuable for the user with respect to the items of information provided by the navigation system.

In one particularly advantageous embodiment, position data describing a current position of the motor vehicle are acquired by an acquisition unit of the motor vehicle. This acquisition unit of the motor vehicle is, for example, a unit which is designed to carry out a position determination of the motor vehicle with the aid of a global navigation satellite system (GNSS). For this purpose, for example, a global positioning system (GPS) can be used as a GNSS. The acquisition unit can represent, for example, a component of the navigation system of the motor vehicle. The acquisition unit can alternatively be provided as an individual device in the motor vehicle.

By evaluating the position data acquired by the acquisition unit, an ego vehicle representation of the motor vehicle anchored in the map is provided in the generated map. A three-dimensional representation of the motor vehicle itself, for example, is generated as the ego vehicle representation, which is shown in a rear view, for example. Upon observation of the generated map having ego vehicle representation shown therein, the user thus looks from the rear at the ego vehicle representation symbolizing his own motor vehicle. Alternatively to the representation of a motor vehicle, the ego vehicle representation can be designed as a predetermined symbol, for example, as a vehicle shown from above and/or as a ball. An ego vehicle, that is to say one's own motor vehicle, is thus shown to identify one's own position in the surroundings in a sufficient size within the generated map.

It is to be emphasized that the arrangement of the ego vehicle representation within the generated map corresponds to the actual current position of the motor vehicle in the surroundings shown in the map. During a movement of the motor vehicle, for example, along the route, the ego vehicle representation moves relative to the other objects in the generated map according to the forward movement of the motor vehicle, i.e., according to the forward movement direction and at the forward movement speed of the forward movement of the motor vehicle. In this way, it is more easily possible for the user to acquire the relative arrangement of his own current position in the displayed surroundings. Because the user can find his own motor vehicle quickly and easily in the map, it is easier for him to rediscover and locate the items of information shown there relating to the surroundings, the route-related navigation notice representation, and the driver assistance system-related additional information representations in the actual surroundings of the motor vehicle perceived by him. In addition, a current status of the motor vehicle can be displayed in the surroundings of the ego vehicle representation, for example, the status “turn signal to the right activated”. The items of information known about the motor vehicle relating to predetermined statuses of the motor vehicle can therefore be depicted in the generated map.

Furthermore, a representation of the three-dimensional surroundings within the map can be adapted in dependence on the selection of the ego vehicle representation. The ego vehicle representation is possibly used not only to identify the current position in conjunction with the navigation system, but is also used to represent the used and activated driver assistance systems. For example, in the event of an active lane departure warning of a lane keeping assistant, this can be marked by a corresponding coloration and/or positioning of the ego vehicle representation within the generated map. The position and representation of the ego vehicle representation can additionally adapt to a curvature, for example, of a road within the map. In the case of an adaptive driving assistant as the activated driver assistance system, a corresponding symbol describing the activated driving assistant can be shown on the map, for example, directly in the vicinity of the ego vehicle representation of the motor vehicle and/or can be shown in a status line above, below, and/or laterally to the map. In the case of showing in the map, the corresponding symbol can be shown, for example, on, above, below, to the left, and/or to the right of the ego vehicle representation.

In a further embodiment, it is provided that an arrangement of the ego vehicle representation and/or the driver assistance system-related additional information representation is generated accurately by lane in the generated map. Both the ego vehicle and also additional information representations, for example, the motor vehicle representation of the front vehicle and/or the notice representation relating to the other motor vehicle located laterally to the motor vehicle therefore takes place accurately by position and lane if multiple lanes are present. Different degrees of detail can be provided here in various embodiments. For example, it can be provided that the other motor vehicle arranged laterally to the motor vehicle is only shown as a simplified symbol, for example, as a ball, and not as the actual motor vehicle representation. Similarly thereto, a simplified representation for the front vehicle as the motor vehicle representation is possible. These various degrees of detail can be selected, for example, in dependence on a country in which the three-dimensional map is displayed for the user of the motor vehicle by the display device of the motor vehicle. In this way, the items of information prepared for the user by the ego vehicle representation and/or the driver assistance system-related additional information representation are recognized and interpreted particularly reliably by the user, since he can rely on exact positioning within the generated map.

Moreover, one embodiment provides that one of the following driver assistance systems is activated in the motor vehicle as the at least one driver assistance system: an adaptive driving assistant, a lane keeping assistant, an intersection assistant, a lane changing assistant, a congestion pilot, a local hazard warning, a predictive speed limit, a predictive efficiency assistant, a turnoff assistant, an adaptive cruise control, an emergency braking assistant, an evasion assistant, a maneuvering assistant, a traffic sign recognition, a traffic signal information assistant, and/or a parking assistant. Numerous different driver assistance systems are thus conceivable in the motor vehicle, upon the respective activation of which the above-described method is carried out, so that ultimately for precisely the activated driver assistance system, the at least one driver assistance system-related additional information representation of the generated map is provided. In addition to the mentioned driver assistance systems, further driver assistance systems are also conceivable, upon the activation of which the method can be carried out. The field of use for the method is thus particularly broad, since for a fundamentally arbitrary driver assistance system, corresponding driver assistance system-related additional information representations can be shown in the map. The method is thus usable in a versatile manner.

In addition, one embodiment provides that surroundings data describing the surroundings of the motor vehicle are received by a communication connection of an external server unit, another motor vehicle, and/or an infrastructure unit in the motor vehicle. The surroundings data can include, for example, items of information about objects located in the surroundings, for example, traffic signs, other motor vehicles, and/or infrastructure units such as a traffic signal and/or an intersection. However, the surroundings data can alternatively or additionally thereto relate to items of information about a traffic flow, so that, for example, items of information about congestion to be expected can be provided as surroundings data. Such data can be received, for example, from the external unit, such as the external server unit, which provides, for example, items of information on a current congestion volume, a weather condition, and/or an arrangement of traffic signals in the surroundings of the motor vehicle. In the case of a communication connection of the motor vehicle to another motor vehicle, that is to say in the case of a vehicle-to-vehicle communication connection, for example, accurate position data of the other motor vehicle can be transmitted, which can be of interest, for example, for the adaptive cruise control, since the other motor vehicle can possibly determine its own position more accurately than is possible by the sensor unit of the motor vehicle. The infrastructure unit is, for example, a traffic signal control unit. In particular, a traffic signal information assistant often operates using received data, which can be transmitted by a traffic signal control unit itself to the motor vehicle in the form of the surroundings data mentioned here. These received surroundings data are evaluated to generate the at least one driver assistance system-related additional information representations of the generated map. In addition to the sensor data which are acquired using the motor vehicle itself, the received surroundings data can thus additionally be used to generate reliable and accurate driver assistance system-related additional information representations and to provide them to the user in the generated map.

The communication connection between the motor vehicle and the external unit, the other motor vehicle, and/or the infrastructure unit can be provided as a wireless connection, for example, via a wireless local network (WLAN for wireless local area network), a Bluetooth connection, and/or a mobile data network, for example, based on the mobile wireless standard long-term evolution (LTE), long-term evolution advanced (LTE-A), or fifth-generation (5G).

The motor vehicle has a navigation system and at least one driver assistance system and is designed to carry out the above-described method. The embodiments presented in conjunction with the method and the advantages thereof apply accordingly, if applicable, to the motor vehicle. For this reason, the corresponding refinements of the motor vehicle are not described once again here.

The motor vehicle may be an automobile, in particular a passenger vehicle or truck, or a bus or motorcycle.

A control unit of the motor vehicle has a processor unit, which is configured to carry out an embodiment of the method. The processor unit can have for this purpose at least one microprocessor and/or at least one microcontroller and/or at least one FPGA (field programmable gate array) and/or at least one DSP (digital signal processor). Furthermore, the processor unit can have program code which is configured, upon execution by the processor unit, to carry out the embodiment of the method. The program code can be stored in a data memory of the processor unit.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic plan view of a motor vehicle which is approaching an intersection; and

FIG. 2 is a schematic representation of a three-dimensional perspective view of the surroundings of a motor vehicle which is driving toward an intersection.

### DETAILED DESCRIPTION

In the exemplary embodiments explained hereinafter, the described components of the embodiments each represent individual features to be considered independently of one another, which are each also to refine the invention independently of one another. The disclosure is therefore also to include combinations of the features of the embodiments other than those shown. Furthermore, the described embodiments can also be supplemented by further features already described.

In the figures, identical reference signs each identify functionally identical elements.

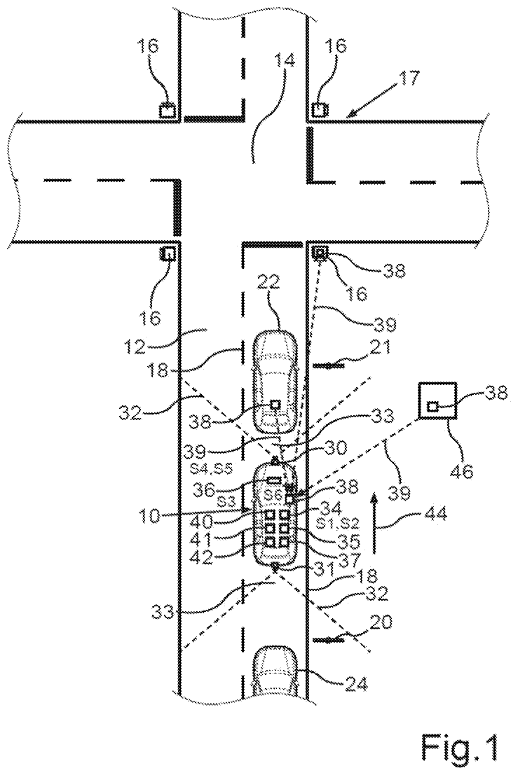

A motor vehicle 10 is sketched in FIG. 1, which is driving on a road 12. It is approaching an intersection 14, wherein respective traffic signals 16 for regulating a traffic situation occurring there are provided at this intersection 14. The road 12 has lane markings 18, which are a central strip marking and a roadway edge marking. Moreover, two traffic signs 20, 21 stand at the edge of the road 12.

The motor vehicle 10 drives behind another motor vehicle 10, which is referred to here as the front vehicle 22. A rear vehicle 24 drives behind the motor vehicle 10.

The motor vehicle 10 has two sensor units 30, 31, which are formed in detail as a front camera 30 and a rear camera 31. A respective acquisition region 32 of the front camera 30 and the rear camera 31 is outlined by dashed lines in each case in FIG. 1. The motor vehicle 10 moreover has a navigation system 34, an acquisition unit 35, a display device 36, a control unit 37, and a communication interface 38. The acquisition unit 35 of the motor vehicle 10 is a unit which can carry out a position determination of the motor vehicle 10 by using a global navigation satellite system (GNSS). The communication interface 38 is designed to establish a communication connection 39 to a communication interface 38 of an external server unit 46, which is an external unit here. The communication connection 39 is designed here as a wireless communication connection 39. Surroundings data describing the surroundings 33 of the motor vehicle 10 can be transmitted to the motor vehicle 10 by the communication connection 39. These surroundings data are, for example, items of traffic flow information, weather information, and/or a hazard message.

The communication connection 39, which can be designed as a vehicle-to-vehicle communication connection, can also be established between the communication interface 38 of the motor vehicle 10 and the communication interface 38 of the front vehicle 22. Via this communication connection 39, the front vehicle 22 can transmit an ego position in the form of corresponding ego position data to the motor vehicle 10, so that the surroundings data in this case describe an accurately determined position of the front vehicle 22. Alternatively or additionally thereto, data acquired via the communication connection 39 from the front vehicle 22 and describing the surroundings 33 of the front vehicle 22 can be transmitted as surroundings data to the motor vehicle 10. Alternatively or additionally thereto, the communication connection 39 can be established between the communication interface 38 of the motor vehicle 10 and a communication interface 38 of the traffic signal 16. In this case, this is the traffic signal 16 which will be reached next by the motor vehicle 10 along a forward movement direction 44 of the motor vehicle 10 along a route of the motor vehicle 10. This communication connection 39 is thus established between the motor vehicle 10 and an infrastructure unit 17 in the form of the traffic signal 16. Both the intersection 14 and also the four traffic signals 16 are sketched here as the infrastructure unit 17. Items of information about traffic signal switching can be transmitted from the traffic signal 16 as the infrastructure unit 17 to the motor vehicle 10 via the communication connection 39, for example.

The respective acquisition regions 32 of the front camera 30 and the rear camera 31 enable an acquisition of predetermined sensor data describing the surroundings 33 of the motor vehicle 10. These sensor data are camera data here. Alternatively thereto, the at least one sensor unit 30, 31 of the motor vehicle 10 can be at least one radar device, a lidar device (lidar for light detection and ranging), an infrared sensor, and/or a side camera of the motor vehicle 10.

The motor vehicle 10 moreover has three driver assistance systems 40, 41, 42. The driver assistance system 40 is a lane keeping assistant, the driver assistance system 41 is an adaptive cruise control, and the driver assistance system 42 is a traffic signal information assistant. A respective one of the three driver assistance systems 40, 41, 42 can be activated in the motor vehicle 10. In addition, at least one of the following further driver assistance systems 40, 41, 42 can be provided in the motor vehicle 10: an adaptive driving assistant, an intersection assistant, a lane changing assistant, a congestion pilot, a local hazard warning, a predictive speed limit, a predictive efficiency assistant, a turnoff assistant, an emergency braking assistant, an evasion assistant, a maneuvering assistant, a traffic sign recognition, and/or a parking assistant.

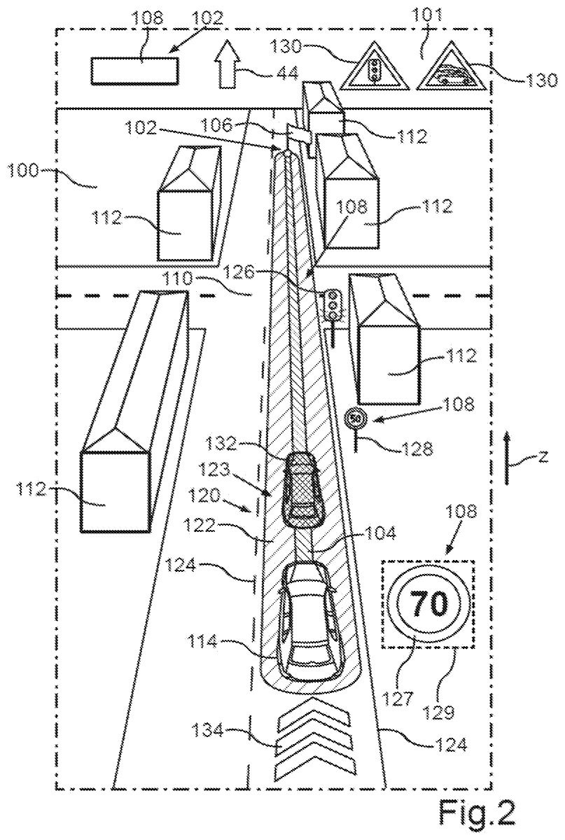

A three-dimensional map 100 is sketched in FIG. 2, which is displayed for a user of the motor vehicle 10 on the display device 36 of the motor vehicle 10. The three-dimensional map 100 is initially generated by the navigation system 34 of the motor vehicle 10, wherein the generated map 100 displays the surroundings 33 of the motor vehicle 10 in a three-dimensional representation. This takes place in S1. Reference characters S1 to S6 are shown in FIG. 1, whereas details relating to the three-dimensional map 100 are sketched in FIG. 2. In S2, a route-related navigation representation 102 is generated in the generated map 100 by evaluating navigation system data of the navigation system 34 if route guidance by the navigation system 34 is activated. The route-related navigation representation 102 includes a route representation 104 of at least a subsection of a route of the motor vehicle 10. This route representation 104 is shown in FIG. 2 as a line extending from a current position of the motor vehicle 10 to a predetermined target position 106. The current position of the motor vehicle 10 is sketched in the form of an ego vehicle representation 114. For its determination, position data describing a current position of the motor vehicle 10 are acquired by the acquisition unit 35 of the motor vehicle 10 and by evaluating the acquired position data, the ego vehicle representation 114 of the motor vehicle 10 located in the map 100 is provided in the generated map 100. The ego vehicle representation 114 corresponds here to a schematically shown motor vehicle 10 viewed from the rear. The ego vehicle representation 114 is positioned accurately by lane in the generated map 100 in this case. Alternatively to the ego vehicle representation 114 shown here as a rear vehicle representation, the ego vehicle representation 114 can be shown from a bird's-eye view.

Furthermore, the route-related navigation representation 102 is a navigation notice representation 108. An item of information relating to a current course of the route can be displayed as the navigation route representation 108, such as items of information about a recommended lane on which the motor vehicle 10 should drive on the basis of the route. Moreover, a symbol 110 describing a current and/or future road situation can be shown in the generated map 100 as the navigation notice representation 108. This is, for example, an intersection 14 and/or a representation of the traffic signal 16. It is thus an infrastructure representation 126 of the traffic signal 16 here.

The navigation representation 102 can be at least partially arranged in an edge region 101 of the generated map 100. In addition, a forward movement direction 44 in the form of an arrow is displayed therein, as well as a distance specification to a next navigation event as a navigation notice representation 108.

The current navigation notice representation 108 can alternatively or additionally thereto be displayed in the form of a traffic sign 127 in the generated map 100. The traffic sign 127 as the current navigation notice representation 108 can be positioned at a predetermined navigation notice representation position 129 within the generated map 100. The navigation notice representation position 129 is sketched in FIG. 2 with the aid of dashed lines and is located at a bottom right edge of the generated map 100 in the viewing direction on the map 100.

Moreover, the future navigation notice representation 108 describing the future road information can be generated in the form of a future traffic sign 128 by evaluating the navigation system data. Specifically, the motor vehicle 10 is currently underway in a section of the road 12 in which the speed limit according to the traffic sign 127 is 70 km/h. In the region of the front vehicle 22, however, this speed limit specification changes according to the traffic sign 128 to 50 km/h, which does not yet apply currently to the motor vehicle 10, but only in the future. The traffic sign 128 is thus a generated future navigation notice representation 108 in the map 100. This is located in the map 100 and travels during a forward movement of the motor vehicle 10 within the map 100 in dependence on the forward movement direction 44 and a forward movement speed of the forward movement of the motor vehicle 10 up to the navigation notice representation position 129. Specifically, as soon as the motor vehicle 10 is actually located in the region of the future traffic sign 128, the representation will have changed on the generated map 100 in such a way that instead of the current traffic sign 127, the presently still future traffic sign 128 will be arranged in the region of the navigation notice representation position 129.

In S3, it is checked whether the at least one driver assistance system 40, 41, 42 of the motor vehicle 10 is activated. If the at least one driver assistance system 40, 41, 42 is activated, in S4, the sensor unit 30, 31 is activated, so that this acquires predetermined sensor data describing the surroundings 33 of the motor vehicle 10, and does so according to a data acquisition rule of the at least one activated driver assistance system 40, 41, 42. In this case, three driver assistance systems 40, 41, 42 are activated. Due to the activity of the lane keeping assistant as the driver assistance system 40, a lane marking 18 of the road 12 is acquired as sensor data and additionally shown in the generated map 100 as a corresponding lane boundary representation 124.

In S5, at least one driver assistance system-related additional information representation 120 is generated in the generated map 100 by selecting the acquired sensor data. The lane boundary representation 124, as it is shown in the generated map 100, is thus a symbol 110 describing a road situation, which is shown as the driver assistance system-related additional information representation 120 in the generated map 100. Due to the activated lane keeping assistant as the driver assistance system 40, moreover a driving tube 122 is displayed as a maneuvering notice 123. In this way, it is made clear to the user that the motor vehicle 10 is controlled due to the lane keeping assistant in such a way that it drives in the region of the sketched driving tube 122. Alternative maneuvering notices 123 can be a directional arrow and/or an arrow in general, for example, to display the lane and/or a current deviation from the lane.

Due to the activity of the adaptive cruise control as a further active driver assistance system 41, moreover the front vehicle 22 is shown in the form of a motor vehicle representation 132 in the generated map 100. This is because the front vehicle 22 is an object 22 described by the acquired sensor data in the surroundings 33 of the motor vehicle 10, which is used by the activated driver assistance system 41 for the purpose of carrying out a driver assistance function of the driver assistance system 41. This driver assistance function is a regulation of the speed of the motor vehicle 10 here to maintain a predetermined distance to the front vehicle 22, that is to say in this case this is a functionality of the adaptive cruise control as the driver assistance system 41. An object representation of the object 22, that is to say the motor vehicle representation 132, is therefore located in the map 100 and highlighted by a predetermined marking. The motor vehicle representation 132 is thus marked in color, for example, which is indicated by a shaded area. Alternatively or additionally to the front vehicle 22 as the object 22, a motor vehicle representation 132 of another motor vehicle 10 arranged laterally to the motor vehicle 10 can also be sketched in the generated map 100 (not sketched here).

Moreover, the infrastructure representation 126 of the traffic signal 16 in the generated map 100 is provided highlighted on the basis of the activated traffic signal information assistant as the driver assistance system 42. This infrastructure representation 126 is also a symbol 110 describing the road situation. A further symbol 110 describing the road situation is located by the traffic signs 127, 128 in the generated map 100. For example, if the traffic sign recognition were activated as a driver assistance system 40, 41, 42, the traffic signs 127, 128 could also be identified and/or highlighted by a marking as driver assistance system-related additional information representations 120.

In S6, the generated map 100 is provided with the generated route-related navigation representation 102 and the generated at least one driver assistance system-related additional information representation 120 in the motor vehicle 10 by the display device 36 of the motor vehicle 10.

Moreover, a warning notice 130 is displayed in the edge region 101 as a driver assistance system-related additional information representation 120. This warning notice 130 is a warning message relating to the approaching traffic signal 16 as the infrastructure representation 126 within the generated map 100, as is provided due to the activated traffic signal information assistant. Furthermore, the motor vehicle 10 receives a congestion warning from the external server unit 46, which is also displayed in the form of a warning notice 130. The data evaluated for this purpose are thus evaluated accordingly from surroundings data of the external server unit 46. Alternatively or additionally thereto, this warning notice 130 could be displayed due to an activated congestion pilot and/or an activated local hazard warning as the driver assistance system 40, 41, 42 on the generated map 100. Moreover, it can be possible that the driver assistance system-related additional information representations 120 are not only shown visually, but rather acoustic feedback takes place, for example, a warning tone, an acoustic instruction, and/or an acoustic notice announcement.

Moreover, a notice representation 134 is shown in the generated map 100, which sketches a rear vehicle 24 approaching the motor vehicle 10 from the rear by arrows. The adaptive cruise control as the driver assistance system 41 hereby calls attention to the rear vehicle 24 approaching the motor vehicle 10 from the rear and the driving behavior of this rear vehicle 24 being taken into consideration by the adaptive cruise control when carrying out its driver assistance function. A corresponding notification representation 134 can alternatively or additionally thereto be located in the generated map 100 with respect to another motor vehicle 10 located laterally to the motor vehicle 10. The driver assistance system-related additional information representation 120 is generally also arranged accurately by lane in the generated map 100.

The surroundings data, which are transmitted by the external server unit 46, the front vehicle 22, and/or the infrastructure unit 17 to the motor vehicle 10, are evaluated to generate the at least one driver assistance system-related additional information representation 120 in the generated map 100.

In the case of a required warning notice 130, this is displayed in a particularly dominant manner, as is shown, for example, by the display of the warning notice 130 in the edge region 101 of the generated map 100. If space problems should occur, for example, because a plurality of driver assistance systems 40, 41, 42 is activated, only the currently required and the particularly urgent items of information can be shown as additional information representations 120 according to a prioritization rule, so that, for example, warning notices 130 are shown prioritized with respect to the other mentioned driver assistance system-specific additional information representations 120.

The generated map 100 is an integrated driving display, which represents a combination of a navigation map and the items of information of the driver assistance systems 40, 41, 42. The map material is shown here as a three-dimensional map 100. This three-dimensional map 100 is distinguished by a curvature on a z axis to ideally utilize the limited height in freely programmable instrument clusters and moreover be able to show the ego vehicle representation 114 to identify the ego position of the motor vehicle 10 in a sufficient size. The mentioned curvature of the z axis is not sketched in FIG. 2.

A representation of a sensor unit position, that is to say a position of the front camera 30 and the rear camera 31 relative to the surroundings 33, can be adapted situationally, in order to change the zoom position in the case of a required detailed representation. In particular, it is to be noted that a respective building 112 in the surroundings 33 is displayed three-dimensionally. The data required for this purpose can be taken from the navigation system data and/or provided by the sensor unit 30, 31. The representation of the various elements, such as the ego vehicle representation 114 and/or the driver assistance system-related additional information representation 120, are shown accurately by lane and position in the generated map 100 and match with the road geometry sketched there.

The operations described with reference to S1 to S6 and the further described evaluation can be executed by the control unit 37.

Overall, the examples show an integrated driving display made up of navigation map and driver assistance system 40, 41, 42.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for providing a three-dimensional map in an operated motor vehicle, which has a navigation system and at least one driver assistance system, comprising:
generating a three-dimensional map by the navigation system with surroundings of the operated motor vehicle in a three-dimensional representation;
generating a route-related navigation representation in the three-dimensional map by evaluating navigation system data of the navigation system, if route guidance by the navigation system is activated;
checking whether the at least one driver assistance system is activated;
acquiring, when the at least one driver assistance system is activated, predetermined sensor data describing the surroundings of the operated motor vehicle by at least one sensor unit of the operated motor vehicle according to a data acquisition rule of the at least one driver assistance system;
generating at least one driver assistance system-related additional information representation in the three-dimensional map by evaluating the sensor data; and
displaying the three-dimensional map having the route-related navigation representation and the at least one driver assistance system-related additional information representation in the operated motor vehicle by a display device of the operated motor vehicle.

12. The method as claimed in claim 11, wherein the driver assistance system-related additional information representation includes at least one of
a maneuvering notice depicted as one of a directional arrow and a driving tube;
a symbol describing a road situation, representing one of a lane boundary, an infrastructure representation, and a traffic sign;
a warning notice;
a motor vehicle representation of a first motor vehicle located one of in front of the operated motor vehicle and laterally to the operated motor vehicle;
a notice representation with respect to one of a second motor vehicle approaching the operated motor vehicle from behind and the first motor vehicle located laterally to the operated motor vehicle.

13. The method as claimed in claim 12, further comprising providing, when the at least one driver assistance system carries out a driver assistance function in consideration of an object described by the sensor data in the surroundings of the operated motor vehicle, an object representation of the object highlighted by a predetermined marking in the three-dimensional map.

14. The method as claimed in claim 13, wherein the route-related navigation representation includes at least one of a route representation of at least one subsection of a route of the operated motor vehicle and a navigation notice representation, including the symbol describing at least one of a current road situation and a future road situation.

15. The method as claimed in claim 14, wherein a current navigation notice representation describing the current road situation is positioned in the three-dimensional map at a predetermined navigation notice representation position, a future navigation notice representation describing the future road situation is generated by evaluating the navigation system data, and the future navigation notice representation is located in the three-dimensional map and moves, during a forward movement of the operated motor vehicle, in the three-dimensional map, in dependence on a forward movement direction and a forward movement speed of the forward movement of the vehicle, to the predetermined navigation notice representation position.

16. The method as claimed in claim 15, wherein position data describing a current position of the operated motor vehicle are acquired by an acquisition unit of the operated motor vehicle, and
wherein the method further comprises determining an ego vehicle representation of the operated motor vehicle in the three-dimensional map by evaluating the position data.

17. The method as claimed in claim 16, wherein an arrangement of at least one of the ego vehicle representation and the driver assistance system-related additional information representation in the three-dimensional map is positioned accurately by lane.

18. The method as claimed in claim 17, wherein the at least one driver assistance system includes at least one of
an adaptive driving assistant;
a lane keeping assistant;
an intersection assistant;
a lane changing assistant;
a congestion pilot;
a local hazard warning;
a predictive speed limit;
a predictive efficiency assistant;
a turnoff assistant;
an adaptive cruise control;
an emergency braking assistant;
an evasion assistant;
a maneuvering assistant;
a traffic sign recognizer;
a traffic signal information assistant; and
a parking assistant.

19. The method as claimed in claim 18, wherein surroundings data describing the surroundings of the operated motor vehicle are received by a communication connection with at least one of an external server unit, another motor vehicle, and an infrastructure unit in the operated motor vehicle, and
wherein the method further comprises generating the at least one driver assistance system-related additional information representation in the three-dimensional map by evaluating the surroundings data.

20. The method as claimed in claim 11, wherein the route-related navigation representation includes at least one of a route representation of at least one subsection of a route of the operated motor vehicle and a navigation notice representation, including a symbol describing at least one of a current road situation and a future road situation.

21. The method as claimed in claim 20, wherein a current navigation notice representation describing the current road situation is positioned in the three-dimensional map at a predetermined navigation notice representation position, a future navigation notice representation describing the future road situation is generated by evaluating the navigation system data, and the future navigation notice representation is located in the three-dimensional map and moves, during a forward movement of the operated motor vehicle, in the three-dimensional map, in dependence on a forward movement direction and a forward movement speed of the forward movement of the vehicle, to the predetermined navigation notice representation position.

22. The method as claimed in claim 11, wherein position data describing a current position of the operated motor vehicle are acquired by an acquisition unit of the operated motor vehicle, and
wherein the method further comprises determining an ego vehicle representation of the operated motor vehicle in the three-dimensional map by evaluating the position data.

23. The method as claimed in claim 22, wherein an arrangement of at least one of the ego vehicle representation and the driver assistance system-related additional information representation in the three-dimensional map is positioned accurately by lane.

24. The method as claimed in claim 11, wherein the at least one driver assistance system includes at least one of
an adaptive driving assistant;
a lane keeping assistant;
an intersection assistant;
a lane changing assistant;
a congestion pilot;
a local hazard warning;
a predictive speed limit;
a predictive efficiency assistant;
a turnoff assistant;
an adaptive cruise control;
an emergency braking assistant;
an evasion assistant;
a maneuvering assistant;
a traffic sign recognizer;
a traffic signal information assistant; and
a parking assistant.

25. The method as claimed in claim 11, wherein surroundings data describing the surroundings of the operated motor vehicle are received by a communication connection with at least one of an external server unit, another motor vehicle, and an infrastructure unit in the operated motor vehicle, and
wherein the method further comprises generating the at least one driver assistance system-related additional information representation in the three-dimensional map by evaluating the surroundings data.

26. A motor vehicle, comprising:
at least one sensor unit;
a navigation system configured to
generate a three-dimensional map with surroundings of said motor vehicle in a three-dimensional representation, and
generate a route-related navigation representation in the three-dimensional map by evaluating navigation system data;
at least one driver assistance system configured to
acquire predetermined sensor data describing the surroundings of said motor vehicle by the at least one sensor unit according to a data acquisition rule of the at least one driver assistance system,
generate at least one driver assistance system-related additional information representation in the three-dimensional map by evaluating the sensor data; and
a display device. coupled to the navigation system and the at least one driver assistance system. configured to display the three-dimensional map with the route-related navigation representation and the at least one driver assistance system-related additional information representation.

27. The motor vehicle as claimed in claim 26,
wherein the at least one sensor unit obtains object data of an object in the surroundings of said motor vehicle, and
wherein the at least one driver assistance system is further configured to perform a driver assistance function based on the object data and produces an object representation of the object highlighted by a predetermined marking in the three-dimensional map.

28. The motor vehicle as claimed in claim 26, wherein the navigation system is further configured to generate as the route-related navigation representation at least one of a route representation of at least one subsection of a route of said motor vehicle and a navigation notice representation including a symbol describing at least one of a current road situation and a future road situation.

29. The motor vehicle as claimed in claim 28, wherein the navigation system is further configured to
generate a current navigation notice representation describing the current road situation positioned in the three-dimensional map at a predetermined navigation notice representation position, and a future navigation notice representation describing the future road situation in the three-dimensional map at a location determined by evaluating the navigation system data, and
move the future navigation notice, during a forward movement of said motor vehicle, in the three-dimensional map, in dependence on a forward movement direction and a forward movement speed of the forward movement of the vehicle, to the predetermined navigation notice representation position.

30. The motor vehicle as claimed in claim 26,
further comprising an acquisition unit configured to acquire position data describing a current position of said motor vehicle, and
wherein the at least one driver assistance system is further configured to generate as the driver assistance system-related additional information representation
a first motor vehicle representation of a first motor vehicle located one of in front and alongside said motor vehicle,
a notice representation with respect to a second motor vehicle one of approaching the operated motor vehicle from behind and located laterally to said motor vehicle, and
a second motor vehicle representation of said motor vehicle in the three-dimensional map based on the position data.
